(19) United States
(12) Patent Application Publication
(10) Pub. No.: US 2015/0075212 A1
(43) Pub. Date: Mar. 19, 2015

(54) Carbon Dioxide Refrigeration System with a Multi-Way Valve

(71) Applicant: The Coca-Cola Company, Atlanta, GA (US)

(72) Inventor: Roberto Horn Pereira, Suwanee, GA (US)

(73) Assignee: The Coca-Cola Company, Atlanta, GA (US)

(21) Appl. No.: 14/027,283

(22) Filed: Sep. 16, 2013

(51) Int. Cl. F25B 41/06; F16K 31/06

(52) U.S. Cl. CPC F25B 41/062; F16K 31/0603
USPC 62/498; 137/870

(57) ABSTRACT

The present application thus provides an expansion device for a refrigeration system. The expansion device may include a multi-way valve with an inlet port, a number of outlet ports, and a selectable valve member movable between a number of open positions related to the outlet ports and a closed position, and a number of capillary tubes in communication with the outlet ports.

### TECHNICAL FIELD

The present application and the resultant patent relate generally to refrigeration systems and more particularly relate to carbon dioxide refrigeration systems used with light commercial or household appliances with an expansion device having a multi-way valve to avoid pressure equalization between compressor cycles for improved energy efficiency.

### BACKGROUND OF THE INVENTION

Modern refrigeration systems provide cooling, ventilation, and humidity control for all or part of an enclosure such as a cooler, a dispenser, and other types of appliances. These modern refrigeration systems are increasing moving away from the use of synthetic refrigerants for a number of reasons. Given such, there is an increased interest in the use of natural refrigerants such as carbon dioxide and the like. Carbon dioxide as a refrigerant has the advantage of being relatively inexpensive, readily available, non-toxic, nonflammable, and environmentally friendly. Moreover, carbon dioxide generally has a higher volumetric capacity than most known synthetic refrigerants.

Generally described, a supercritical or other type of a carbon dioxide refrigeration cycle may be similar to other types of refrigeration cycles but may operate at a higher pressure and may not involve a change in state. The typical carbon dioxide refrigeration cycle may include compressing the flow of carbon dioxide within a compressor at a high pressure and a high temperature. Second, the compressed carbon dioxide may be cooled within a gas cooler or other type of heat exchanger by heat exchange with the surrounding environment. Third, the carbon dioxide passes through an expansion device that reduces both the pressure and the temperature. Fourth, the carbon dioxide may be pumped to an evaporator or further heat exchanger where the carbon dioxide absorbs heat from the enclosure so as to provide cooling. The carbon dioxide then may be returned to the compressor so as to repeat the cycle.

In order to reduce overall energy costs and reduce the buildup of frost, it is common to cycle the compressor on and off. During the off cycles, however, the pressure across the compressor may come to equilibrium. Such equilibrium may require addition compressor time and energy consumption in order to reestablish a suitable compressor pressure.

There is thus a desire for an improved carbon dioxide refrigeration system. Such an improved carbon dioxide refrigeration system may prevent pressure equalization across the high and low pressure sides of the refrigeration system between duty cycles. Avoiding such pressure equalization may result in reduced overall energy consumption and may improve overall system lifetime and availability.

### SUMMARY OF THE INVENTION

The present application and the resultant patent thus provide an expansion device for a refrigeration system. The expansion device may include a multi-way valve with an inlet port, a number of outlet ports, and a selectable valve member movable between a number of open positions related to the outlet ports and a closed position, and a number of capillary tubes in communication with the number of outlet ports.

The present application and the resultant patent further provide a carbon dioxide refrigeration system. The carbon dioxide refrigeration system may include a compressor and an expansion device. The expansion device may include a multi-way valve with an inlet port, a number of outlet ports, and a selectable valve member movable between a number of open positions related to the outlet ports and a closed position. The closed position may maintain a pressure differential across the compressor.

The present application and the resultant patent further provide an expansion device for a carbon dioxide refrigeration system. The expansion device may include multi-way valve system with an inlet line with a solenoid operated inlet valve and a number of outlet lines with a number of solenoid operated outlet valves, and a number of capillary tubes in communication with the outlet lines.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a refrigeration system as may be described herein.

FIG. 2 is a schematic diagram of a three-way valve for use with an expansion device of the refrigeration system of FIG. 1 showing an open first capillary tube.

FIG. 3 is a schematic diagram of the three-way valve of the expansion device for use with the refrigeration system of FIG. 1 showing an open second capillary tube.

FIG. 4 is a schematic diagram of a three-way valve for use with the expansion device of the refrigeration system of FIG. 1 showing both capillary tubes closed.

FIG. 5 is a schematic diagram of an alternative embodiment of a multi-way valve as may be described herein.

### DETAILED DESCRIPTION

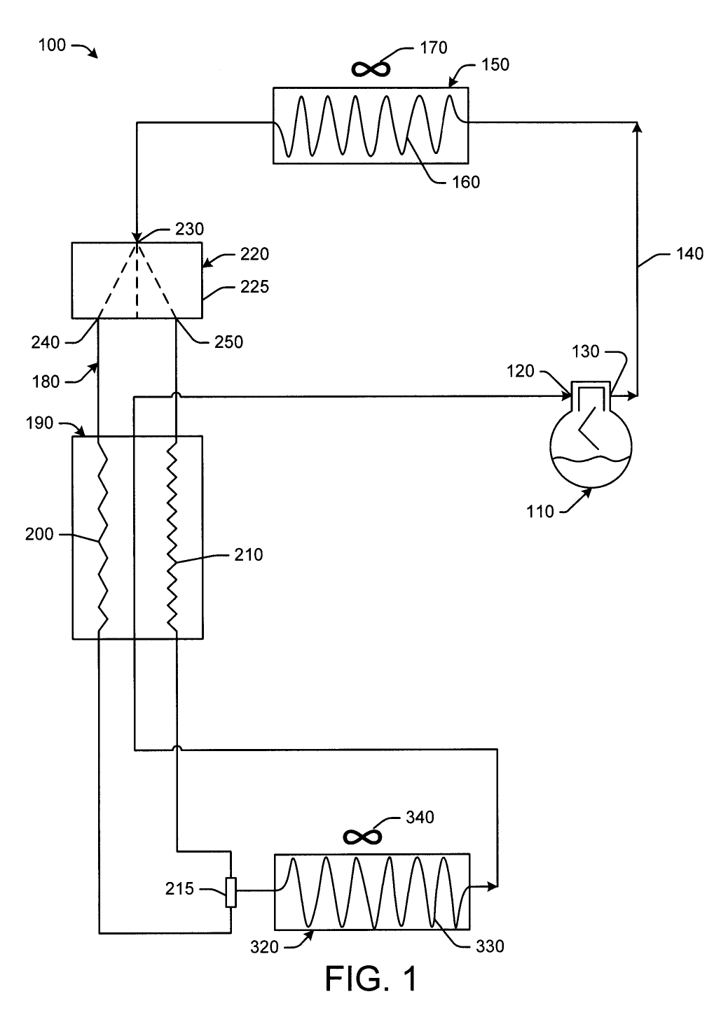

Referring now to the drawings, in which like numerals refer to like elements throughout the several views, FIG. 1 shows an example of a refrigeration system 100 as may be described herein. The refrigeration system 100 may be used to cool any type of enclosure such as a refrigerator, a cooler, a vending machine, a dispenser, and the like. The overall refrigeration system 100 may have any suitable size or capacity. The refrigeration system 100 also may be applicable to air conditioning and/or heating systems. Although primarily directed towards light commercial or house appliances, the refrigeration system 100 thus may have commercial, industrial, and residential applications.

The refrigeration system 100 may include a compressor 110. The compressor 110 may be a single speed compressor, a two speed compressor, a variable capacity compressor, and the like. The compressor 110 may have any suitable size or capacity. When in operation, the compressor 110 may include an upstream low pressure side 120 and a downstream high pressure side 130 with a pressure differential thereacross. The compressor 110 may compress a refrigerant 140 at high pressure and high temperature. The refrigerant 140 may be a flow of carbon dioxide in a supercritical cycle or in a subcritical cycle depending on the ambient temperature in which it operates and the like.

The refrigeration system 100 may include a gas cooler or other type of heat exchanger 150 positioned downstream of the compressor 110. The heat exchanger 150 may have any suitable size or capacity. The heat exchanger 150 may include a number of coils 160 therein or other type of heat exchange surface. A heat exchanger fan 170 may be positioned adjacent thereto. The heat exchanger fan 170 may be a single speed fan, a variable speed fan, and the like. The heat exchanger 150 may cool the refrigerant 140 by heat exchange with the surrounding environment.

The refrigeration system 100 may include an expansion device 180 positioned downstream of the heat exchanger 150. In this example, the expansion device 180 may include a number of capillary tubes 190. A first capillary tube 200 and a second capillary tube 210 are shown although any number of the capillary tubes 190 may be used. The capillary tubes 200, 210 may be positioned in parallel. The first capillary 200 may offer a low flow path resistance. The second capillary tube 210 may offer a higher flow path resistance. The capillary tubes 190 may be of conventional design and may have any suitable size, shape, or configuration. The use of the capillary tubes 190 in the expansion device 180 reduces both the pressure and the temperature of the refrigerant 140. The first capillary tube 200 and the second capillary tube 210 may merge at a downstream T-joint 215. Other components and other configurations may be used herein.

The expansion device 180 also may include a multi-way valve 220 positioned upstream of the capillary tubes 190. In this example, the multi-way valve 220 may be a three-way valve 225 although additional valve ports also may be used herein. The three-way valve 225 thus may include an inlet port 230 positioned downstream of the condenser 150, a first outlet port 240 in communication with the first capillary tube 200, and a second outlet port 250 in communication with the second capillary tube 210. The three-way valve 225 also may include a selectable valve member 260 positioned therein. In this example, the valve member 260 may be in the form of a selection block 270. Other types of valve members may be used herein. The three-way valve 225 may have any suitable size, shape, or configuration.

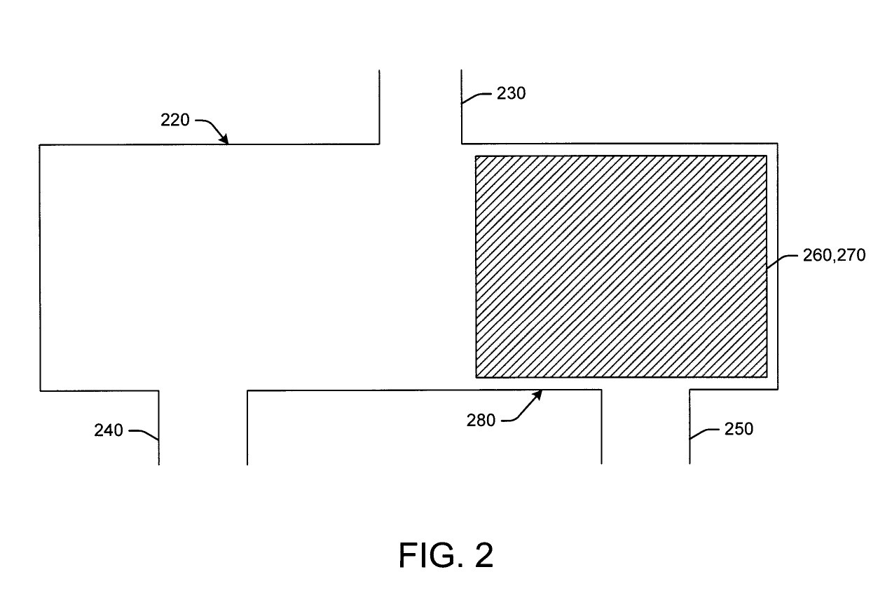

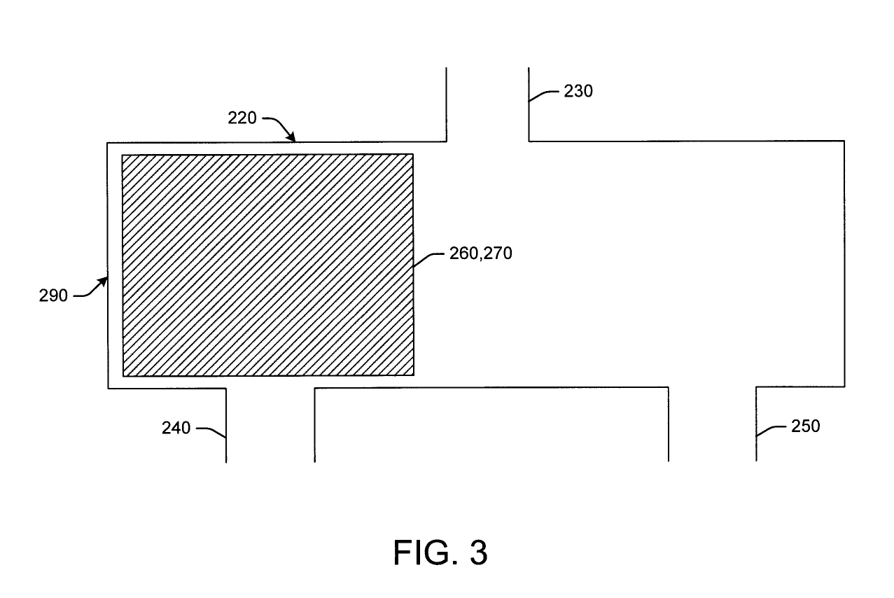

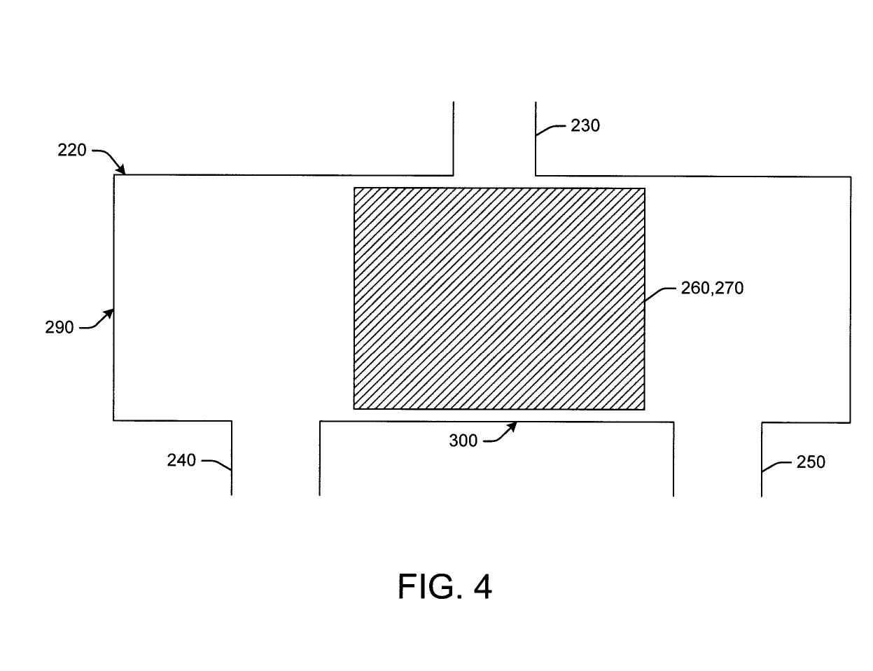

The three-way valve 225 may have three or more different positions. Specifically, the three-way valve 225 may have a first position 280 as is shown in FIG. 2. In the first position 280, the inlet port 230 is open, the first outlet port 240 is open, and the second outlet port 250 is closed. The three-way valve 225 also may have a second position 290 as is shown in FIG. 3. In the second position 290, the inlet port 230 is open, the first outlet port 240 is closed, and the second outlet port 250 is open. The three-way valve 220 also may have a third or a closed position 300 as is shown in FIG. 4. In the third or the closed position 300, the inlet port 230 is closed, the first outlet port 240 is closed, and the second outlet port 250 is closed. No refrigerant 140 thus flows through the three-way valve 225 in the third or the closed position 300. A conventional controller may operate the three-way valve 225 according to many different types of operational parameters and the like. Other components and other configurations also may be used herein.

The refrigeration system 100 also may include an evaporator 320 or other type of heat exchanger positioned downstream of the expansion device 180. The evaporator 320 may have any suitable size or capacity. The evaporator 320 may include a number of evaporator coils 330 or other type of heat exchange surface. An evaporator fan 340 may be positioned adjacent thereto. The evaporator fan 340 may be a single speed fan, a variable speed fan, and the like. The refrigerant 140 may be pumped to the evaporator 320 and may absorb heat with a flow of air blown or drawn across the evaporator coils 330 by the evaporator fan 340 so as to cool an enclosure and the like. The refrigerant 140 then may be returned to the compressor 110 to repeat the cycle. Other components and other configurations may be used herein.

In use, the expansion device 180 with the multi-way valve 220 and the multiple capillary tubes 190 may accommodate different compressor operating conditions. When the refrigeration system 100 is cooling an enclosure down to its desired temperature, the three-way valve 225 may operate in the first position 280 of FIG. 2. Specifically, the first capillary tube 200 with the low flow path resistance is open and the compressor 110 may operate at a high frequency. When the refrigeration system 100 is maintaining an enclosure at a desired temperature, the three-way valve 225 may maneuver to the second position 290 of FIG. 3. Specifically, the second capillary tube 210 with a high flow path resistance is open and the compressor 110 may operate at a lower frequency.

When the compressor 110 is cycled off, the three-way valve 225 may maneuver to the third or the closed positioned 300 of FIG. 4. Specifically, the inlet port 230, the first outlet port 240, and the second outlet port 250 are all closed. By completely closing the three-way valve 225, the refrigerant 140 on the high pressure side 130 of the compressor 110 remains at high pressure while the refrigerant 140 on the low pressure side 120 remains at low pressure with no migration of the refrigerant 140. Maintaining this pressure differential across the compressor 110 may require some additional torque and power input when the compressor 110 is initially cycled on. The total amount of time that the compressor 110 remains on, however, may be reduced such that the overall energy consumption may be reduced. The use of the three-way valve 225 thus may provide an overall reduction in energy consumption for the compressor 120 and the refrigeration system 100 as a whole. Further, the use of the three-way valve 225 may promote overall system reliability and availability.

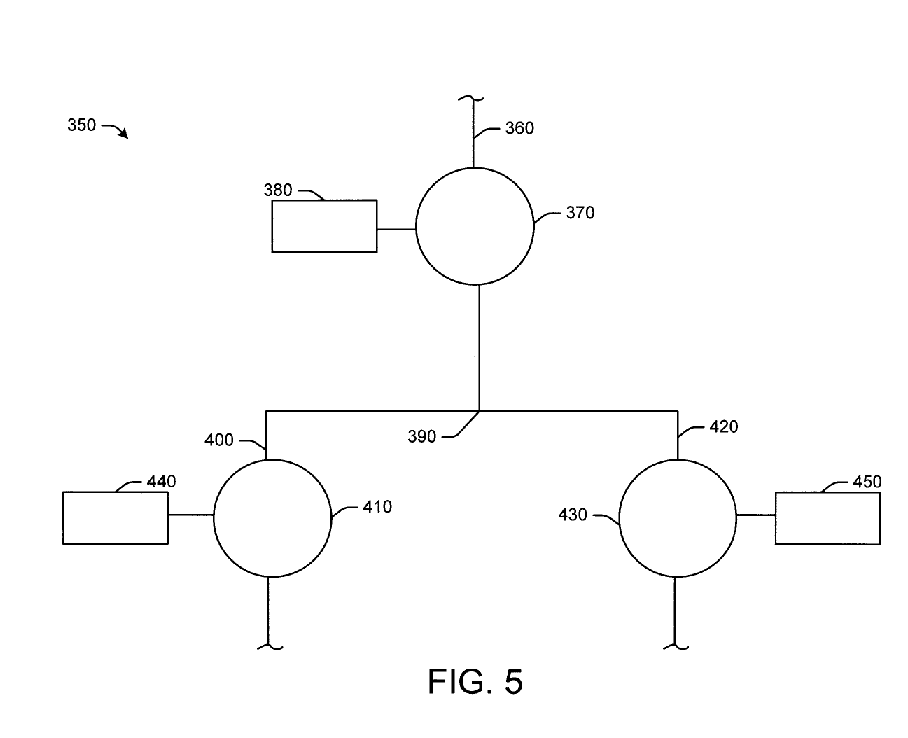

FIG. 5 shows a further embodiment of a multi-way valve system 350 as may be described herein. The multi-way valve system 350 may include an inlet line 360 with an inlet valve 370 thereon downstream of the heat exchanger 150. The inlet valve 370 may be an on/off type valve and may be operated by an inlet solenoid 380 and the like. The multi-way valve system 350 may include a T-joint 390 downstream of the inlet valve 370. The T-joint 390 may lead to a first outlet line 400 with a first outlet valve 410 and to a second outlet line 420 with a second valve 430 thereon. The valves 410, 430 may be on/off valves and the like. The first outlet valve 410 may be operated by a first outlet solenoid 440. The second outlet valve 430 may be operated by a second outlet solenoid 450. Any number of outlet lines, outlet valves, and outlet valve solenoids may be used herein. The valves may be operated by a controller as described above. Other components and other configurations may be used herein.

The multi-way valve system 350 thus may operate in a manner similar to the multi-way valve 220. With the inlet valve 370 open, either the first outlet line 410 and/or the second outlet line 420 may be used. Closing the inlet valve 370 closes the multi-way valve system 350 entirely so as to maintain the pressure different across the compressor 110 and the like. Other components and other configurations may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. An expansion device for a refrigeration system, comprising:
a multi-way valve;
the multi-way valve comprising an inlet port, a plurality of outlet ports, and a selectable valve member movable between a plurality of open positions related to the plurality of outlet ports and a closed position; and
a plurality of capillary tubes in communication with the plurality of outlet ports.

2. The expansion device of claim 1, wherein the plurality of capillary tubes comprises a first capillary tube and a second capillary tube.

3. The expansion device of claim 2, wherein the first capillary tube comprises low flow path resistance.

4. The expansion device of claim 2, wherein the second capillary tube comprises high flow path resistance.

5. The expansion device of claim 2, wherein the first capillary tube and the second capillary tube meet at a T-joint.

6. The expansion device of claim 1, wherein the multi-way valve comprises a three-way valve.

7. The expansion device of claim 1, wherein the plurality of outlet ports comprises a first outlet port and a second outlet port.

8. The expansion device of claim 7, wherein the multi-way valve comprises a first position with the inlet port open, the first outlet port open, and the second outlet port closed.

9. The expansion device of claim 7, wherein the multi-way valve comprises a second position with the inlet port open, the first outlet port closed, and the second outlet port open.

10. The expansion device of claim 7, wherein the closed position comprises the inlet port closed, the first outlet port closed, and the second outlet port closed.

11. The expansion device of claim 1, wherein the selectable valve member comprises a selection block.

12. The expansion device of claim 1, wherein the multi-way valve comprises a solenoid.

13. A carbon dioxide refrigeration system, comprising:
a compressor; and
an expansion device;
the expansion device comprising a multi-way valve;
the multi-way valve comprising an inlet port, a plurality of outlet ports, and a selectable valve member movable between a plurality of open positions related to the plurality of outlet ports and a closed position; and
wherein the closed position maintains a pressure differential across the compressor.

14. The refrigeration system of claim 13, further comprising a plurality of capillary tubes in communication with the plurality of outlet ports.

15. The refrigeration system of claim 14, wherein the plurality of capillary tubes comprises a first capillary tube with low flow path resistance and a second capillary tube with high flow path resistance.

16. The refrigeration system of claim 13, wherein the multi-way valve comprises a three-way valve.

17. The refrigeration system of claim 13, wherein the multi-way valve comprises a first position with the inlet port open, a first outlet port open, and a second outlet port closed.

18. The refrigeration system of claim 13, wherein the multi-way valve comprises a second position with the inlet port open, a first outlet port closed, and a second outlet port open.

19. The refrigeration system of claim 13, wherein the closed position comprises the inlet port closed, a first outlet port closed, and a second outlet port closed.

20. An expansion device for a carbon dioxide refrigeration system, comprising:
a multi-way valve system;
the multi-way valve system comprising an inlet line with a solenoid operated inlet valve and a plurality of outlet lines with a plurality of solenoid operated outlet valves; and
a plurality of capillary tubes in communication with the plurality of outlet lines.
